(19) United States
(12) Patent Application Publication
(10) Pub. No.: US 2016/0080702 A1
(43) Pub. Date: Mar. 17, 2016

(54) SYSTEMS AND METHODS FOR CONTROLLING MULTIPLE AERIAL UNITS

(71) Applicants: Gabriel Shachor, Maccabim Reut (IL); Shy Cohen, Yokneam Moshava (IL)

(72) Inventors: Gabriel Shachor, Maccabim Reut (IL); Shy Cohen, Yokneam Moshava (IL)

(21) Appl. No.: 14/849,598

(22) Filed: Sep. 10, 2015

Related U.S. Application Data
(60) Provisional application No. 62/048,842, filed on Sep. 11, 2014.

(51) Int. Cl. H04N 7/18; H04N 5/232

(52) U.S. Cl. CPC H04N 7/183; H04N 5/23293

(57) ABSTRACT

A system that includes a ground unit, an aerial unit and a connecting element that is arranged to connect the ground unit to the aerial unit; wherein the ground unit comprises a connecting element manipulator that is arranged to alter an effective length of the connecting element; wherein the effective length of the connecting element defines a distance between the ground unit and the aerial unit; wherein at least one out of the ground unit and the aerial unit comprises a controller; wherein the controller is configured to determine the manner in which the aerial unit operates and is further configured to assist in a controlling of an aerial monitoring device that differs from the aerial unit.

### RELATED APPLICATIONS

This application claims priority from U.S. provisional patent Ser. No. 62/048,842 filing date Sep. 11 2014 which is incorporated herein by reference.

### BACKGROUND OF THE INVENTION

PCT patent application PCT/IB2011/055021 International filing date Nov. 10 2011 illustrates a highly sophisticated system.

The system includes an aerial unit that is controlled by a ground unit. The aerial unit is connected to the ground unit via a connecting element.

The aerial unit may monitor an area. There may be a need perform additional monitoring of the area and/or monitoring additional areas.

### SUMMARY

There may be provided a system that may include a ground unit, an aerial unit and a connecting element that is arranged to connect the ground unit to the aerial unit; wherein the ground unit comprises a connecting element manipulator that is arranged to alter an effective length of the connecting element; wherein the effective length of the connecting element defines a distance between the ground unit and the aerial unit; wherein at least one out of the ground unit and the aerial unit comprises a controller; wherein the controller may be configured to determine the manner in which the aerial unit operates and is further configured to assist in a controlling of an aerial monitoring device that differs from the aerial unit.

The controller may be configured to assist in the controlling of the aerial monitoring device that differs from the aerial unit in response to instructions fed to the system by a user.

The controller may be configured to assist in the controlling of the aerial monitoring device in an autonomous manner.

The controller may be configured to assist in the controlling of the aerial monitoring device by sending to the aerial monitoring device target information about a location of a target to be monitored by the aerial monitoring device.

The controller may be configured to assist in the controlling of the aerial monitoring device by sending to the aerial monitoring device control information that is relayed by the aerial unit.

The controller may be configured to receive monitoring information from the aerial monitoring device and to control a display to a user of the monitoring information.

The system may include a display that may be configured to display to a user monitoring information from the aerial monitoring device and monitoring information from the aerial unit.

The controller may be configured to assist in a controlling of at least one additional aerial monitoring devices.

The aerial monitoring device may be a satellite.

The aerial monitoring device may be a blimp

There may be provided a system that may include a ground unit, an aerial unit and a connecting element that is arranged to connect the ground unit to the aerial unit; wherein the ground unit comprises a first controller and a connecting element manipulator that is arranged to alter an effective length of the connecting element; wherein the effective length of the connecting element defines a distance between the ground unit and the aerial unit; wherein the first controller may be configured to determine the manner in which the aerial unit operates; wherein the aerial unit comprises a second controller that may be configured to assist in a controlling of an aerial monitoring device that differs from the aerial unit.

The aerial monitoring unit differs from the aerial unit by at least one out of resolution a spectrum.

There may be provided a method for controlling an aerial unit and an aerial monitoring device, the method may include operating the aerial unit and a ground unit to provide an image of an area; wherein the aerial unit and the ground unit are connected to each other by a connecting element; wherein the ground unit comprises a connecting element manipulator that is arranged to alter an effective length of the connecting element; wherein the effective length of the connecting element defines a distance between the ground unit and the aerial unit; selecting a target to be viewed by the aerial monitoring device; sending control information to the aerial monitoring device to enable a monitoring of a target by the aerial monitoring device; receiving monitoring information received from the aerial monitoring device; and displaying the monitoring information.

The method may include assisting in a controlling of the aerial monitoring device in response to instructions fed to the system by a user.

The method may include assisting in a controlling of the aerial monitoring device in an autonomous manner.

The method may include assisting in a controlling of the aerial monitoring device by sending to the aerial monitoring device target information about a location of a target to be monitored by the aerial monitoring device.

The method may include assisting in a controlling of the aerial monitoring device by sending to the aerial monitoring device control information that is relayed by the aerial unit.

The method may include assisting in a controlling of at least one additional aerial monitoring device that differs from the aerial unit.

The aerial monitoring device may be a satellite.

The aerial monitoring device may be a blimp

The displaying the monitoring information may include displaying monitoring information received from the aerial unit at a first window and displaying monitoring information received from the aerial monitoring device at a second window.

### BRIEF DESCRIPTION OF THE DRAWINGS

Further features and advantages of the invention will be apparent from the description below. The invention is herein described, by way of example only, with reference to the accompanying drawings, wherein:

FIGS. 1A and 1B are general views of a system according to various embodiments of the invention;

FIG. 2 illustrates a screen shot of a display according to an embodiment of the invention;

FIG. 3 illustrates a screen shot of a display according to an embodiment of the invention;

FIG. 4 illustrates a screen shot of a display according to an embodiment of the invention;

FIG. 5 illustrates a screen shot of a display according to an embodiment of the invention;

FIG. 6 illustrates a screen shot of a display according to an embodiment of the invention;

FIG. 7 illustrates a screen shot of a display according to an embodiment of the invention;

FIG. 8 illustrates a screen shot of a display according to an embodiment of the invention;

FIG. 9 illustrates a screen shot of a display according to an embodiment of the invention;

FIG. 10 illustrates a method according to an embodiment of the invention; and

FIG. 11 illustrates a method according to an embodiment of the invention.

### DETAILED DESCRIPTION OF THE DRAWINGS

A system is provided. The system may be used for height spreading of observation, signaling equipment, antennas, transmission relay station, anti-terrorist surveillance, and the like. The system may be a light, compact and portable and may include a ground unit and an aerial unit. The aerial unit orientation and location (displacement) may be controlled within four degrees of freedom while maintaining a built-in stability thereof. The system may be automatically and easily deployed and folded.

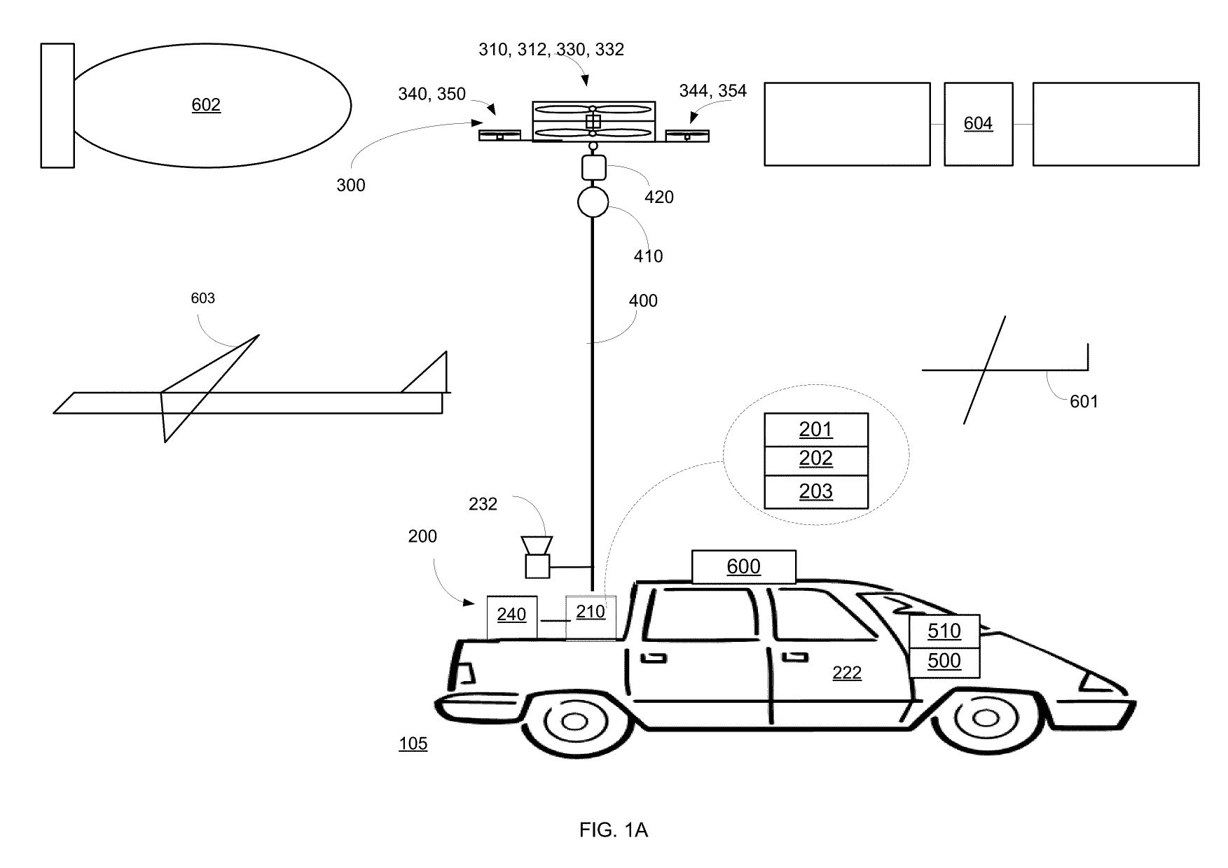

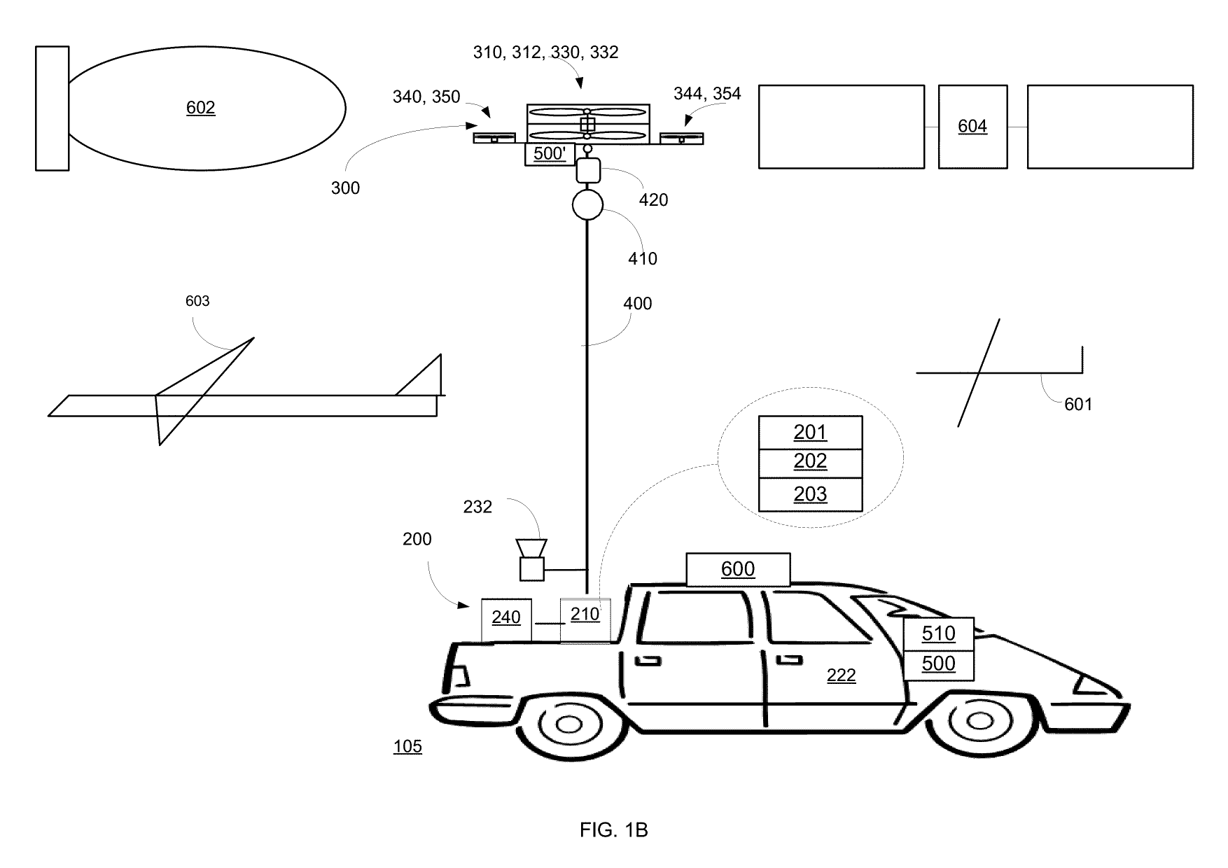

FIG. 1A illustrates a system 105 according to an embodiment of the invention having a ground unit 200 that is carried by a vehicle 222.

The system 105 includes, in addition to ground unit 200, an aerial unit 300 and a connecting element 400 that is arranged to connect the ground unit 200 to the aerial unit 300. The connecting element 400 may be connected to the aerial unit via joint 410 and payload 420 is illustrated between joint 410 and aerial unit. The joint 410 may allow the aerial unit to rotate in relation to connecting element 400.

The ground unit 200 may be positioned on a vehicle such as a van and aerial unit that holds a payload (such as one or more types of equipment) and can lift itself to heights of about thirty meters within approximately ten seconds. It is noted that the aerial unit can lift the equipment to heights that differ from thirty meters and during a period that differs than ten seconds.

The ground unit 200 may include:
i. A connecting element manipulator 201, a base 202 and a ground unit controller 203 (collectively denoted 210), the connecting element manipulator 201 is arranged to alter an effective length of the connecting element; wherein the effective length of the connecting element defines a distance between the ground unit and the aerial unit.
ii. A positioning unit 232 arranged to image the aerial unit and to generate metadata about a location of the aerial unit.
iii. Controller 500 that may be arranged to apply various control schemes and to determine the manner in which the aerial unit 300 operates. The controller can control the speed and the orientation of the aerial unit.

The ground unit 200 may include a power source 240 and a controller 500 and may include a user interface 510 that can allow a user to affect the control scheme of the aerial unit as well as assist in controlling one or more other monitoring devices such as one or more other aerial units—especially aerial units that are not connected to ground unit 200.

The user interface 510 may include a holographic display or any other type of displays that may be located within the vehicle and accessible to the driver or to an operator that differs from the driver. The display may be connected to the dashboard or any other part of the vehicle 222.

Another monitoring device may be a drone, a blimp, an aerial unit connected to other ground units, a satellite, a manned aerial vehicle and the like. FIG. 1 illustrates a drone 601, a blimp 602, airplane 603 and satellite 604. It is noted that the number of monitoring devices and their types may differ from those illustrated in FIG. 1.

The assistance in controlling the other monitoring devices may include determining, by the user (and/or automatically by the system), targets to be viewed by the other monitoring devices and sending information about the targets (such as location information of the targets) to the other monitoring device or to control units that control the other monitoring devices.

For example—the location information of a target can be fed, directly or indirectly, to a drone that in turn may fly to a position that allows the drone to view that target. The location information or any other information that may assist in controlling the other monitoring devices may be sent from the ground unit and/or from the aerial unit or be sent in any manner known in the art. Figure

FIG. 1A also illustrates communication module 600 that is connected to vehicle 222 for communicating with the other monitoring devices and/or with intermediate devices such as control units and the like.

The other monitoring device (one or more) may differ from the aerial unit 300 by resolution, manner of imaging (light frequency, thermal imaging, x-ray imaging), and the like.

The targets may be may selected in various manners. For example, the user may point (directly or using a device) to a target that is displayed on the user interface 510. The target may be included in an area that is imaged by the aerial unit 300.

For example, if the user interface 510 is a touch screen than the user may touch the selected target. Yet for another example the user may use any other manner (using a mouse, keyboard, gesture controlled device, point a laser beam or other beam to the target) to select the target. The selection of the target can be done by using sounds and/or gestures.

The controller 500 may include a computer or other processing hardware components that may determine, after the selection of the target, the location of the target and may transform that information to a format that is acceptable by the other monitoring device.

The controller 500 is shown as being a part of the ground unit 200 but it may be located at a remote position—allowing a controller to remotely control the aerial unit 300 and the other (one or more) monitoring devices. FIG. 1B illustrates a controller 500 within the groups unit and a another controller 500′ within the aerial unit.

According to an embodiment of the invention information sensed by the one or more other monitoring device may be sent to the controller 500 (or to third parties) and may be displayed to the user on user interface 510—or on other user interfaces. The information provides by each other monitoring device may be displayed at a unique area of a display (for example—having a different window for each monitoring device) or be displayed in any other manner (for example the user may toggle between information provided by different monitoring devices including the other monitoring devices and the aerial unit 300).

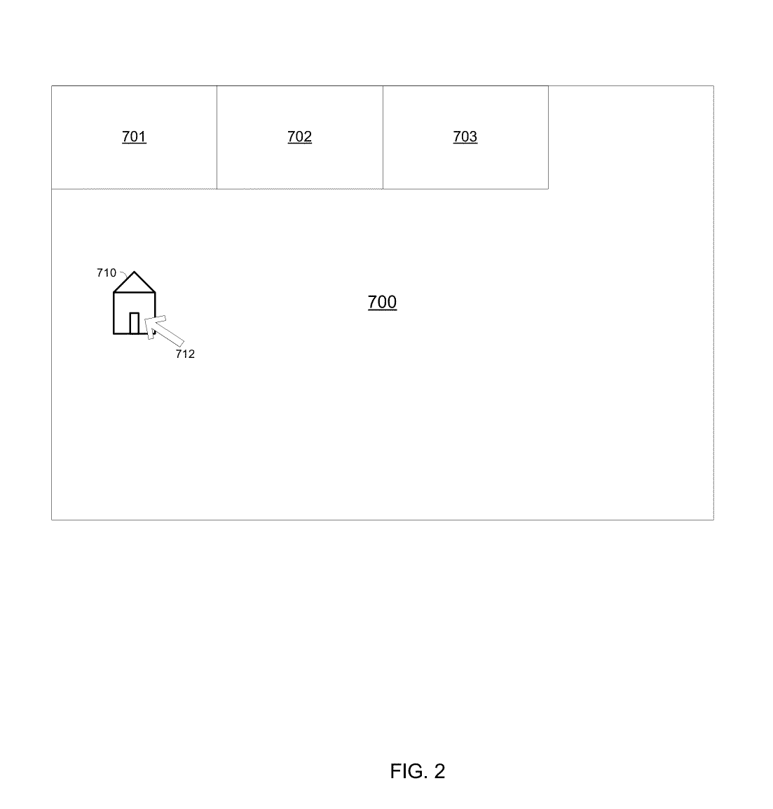

FIG. 2 illustrates a scenario in which different windows 701, 702 and 703 are allocated for three other monitoring devices while a larger window 700 is allocated for displaying the information from the aerial unit 300. This figure also shows a target 710 that is pointed by the user 712 and may be selected to be viewed by an additional monitoring device.

The aerial unit 300 may include a first propeller 310, second propeller 330, a propelling module that includes first and second propellers motors 312 and 332, a frame and at least one steering element (not shown). The first and second propellers are concentric.

Alternatively, and as illustrated in FIG. 1A—the aerial unit 300 includes a “main ” group of propellers (first and second propellers 310 and 330) and four additional groups of propellers (only two are shown in FIGS. 1A and 1B)—the first additional group of propellers includes first additional propeller 340 driven by first additional motor 350 and the second additional group of propellers includes first additional propeller 344 driven by second additional motor 354.

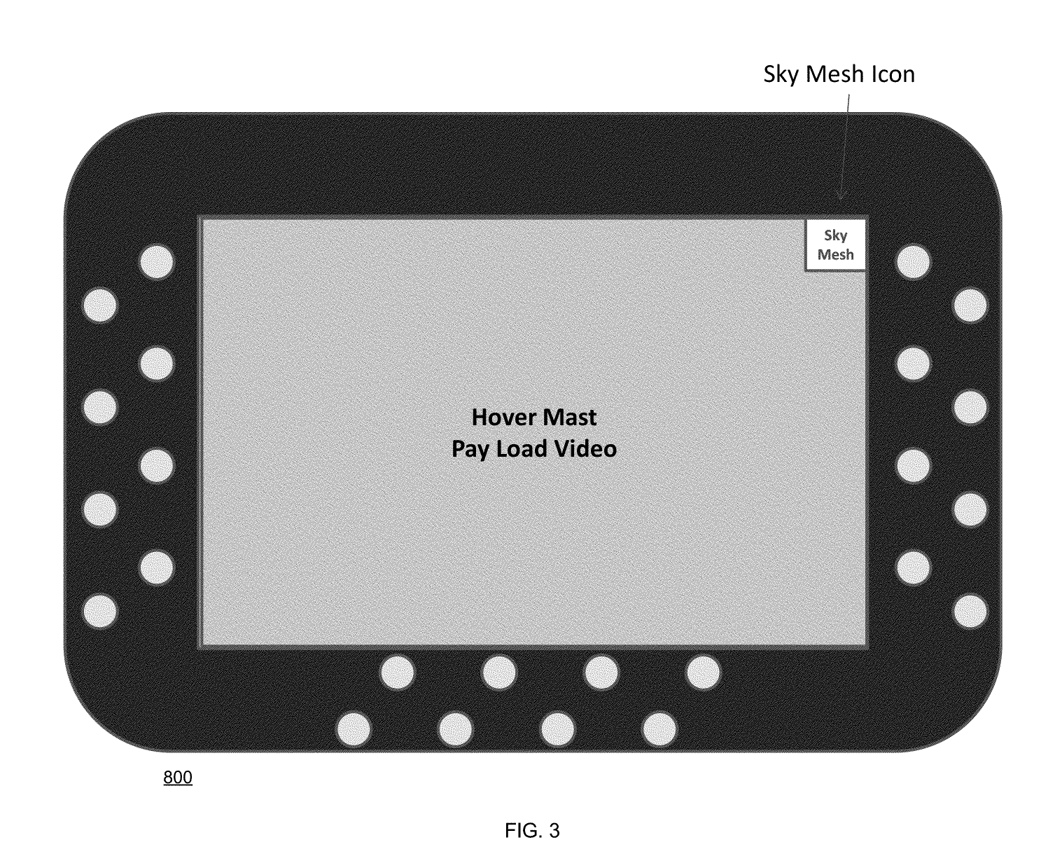

FIGS. 3-9 illustrates various screen shots 800 and 900 of content that can be displayed to a user according to various embodiments of the invention.

In FIG. 3 a central portion of the display 700 is allocated to displaying information obtained by aerial unit 300 (hover mast payload video”). This central portion also includes an icon related to another monitoring device (sky mesh icon). The central portion is surrounded by an area that may include multiple control icons.

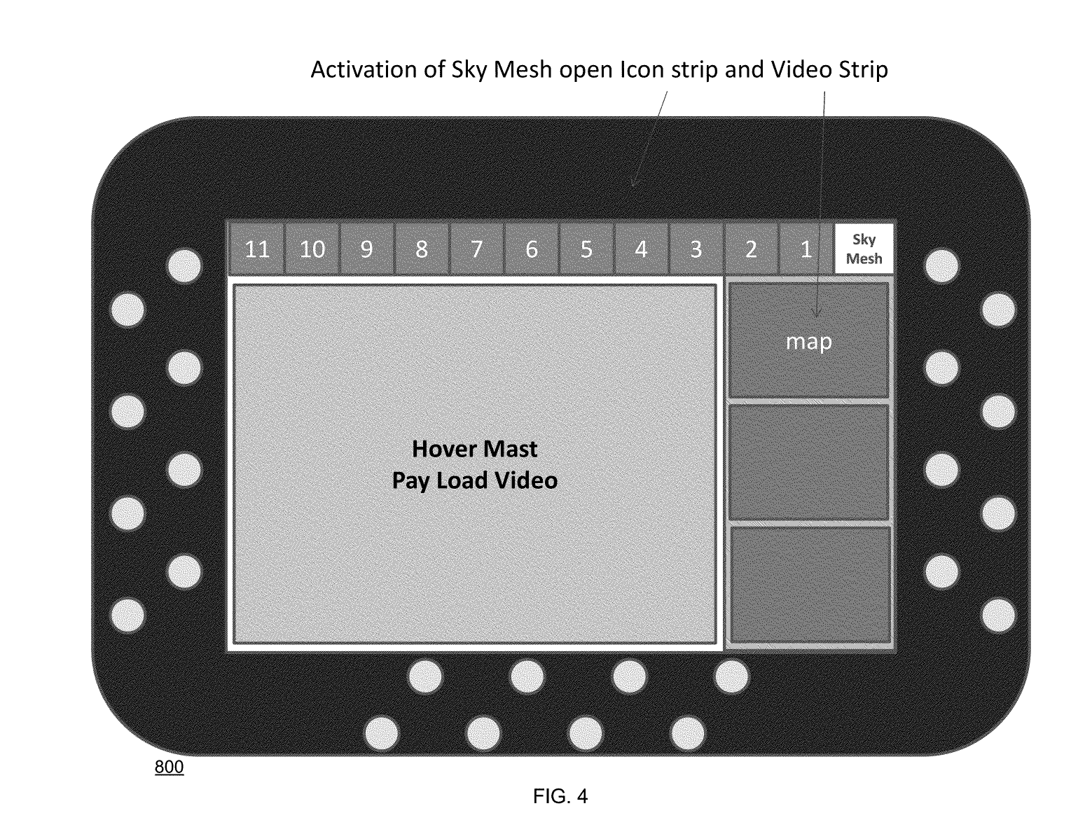

FIG. 4 further shows (a) a horizontal line of icons denoted 1-10 for selecting up to ten additional monitoring devices to be activated for monitoring targets, and (b) vertical sequence of windows (one denoted “map”) for displaying the content obtained by one or more aerial monitoring devices.

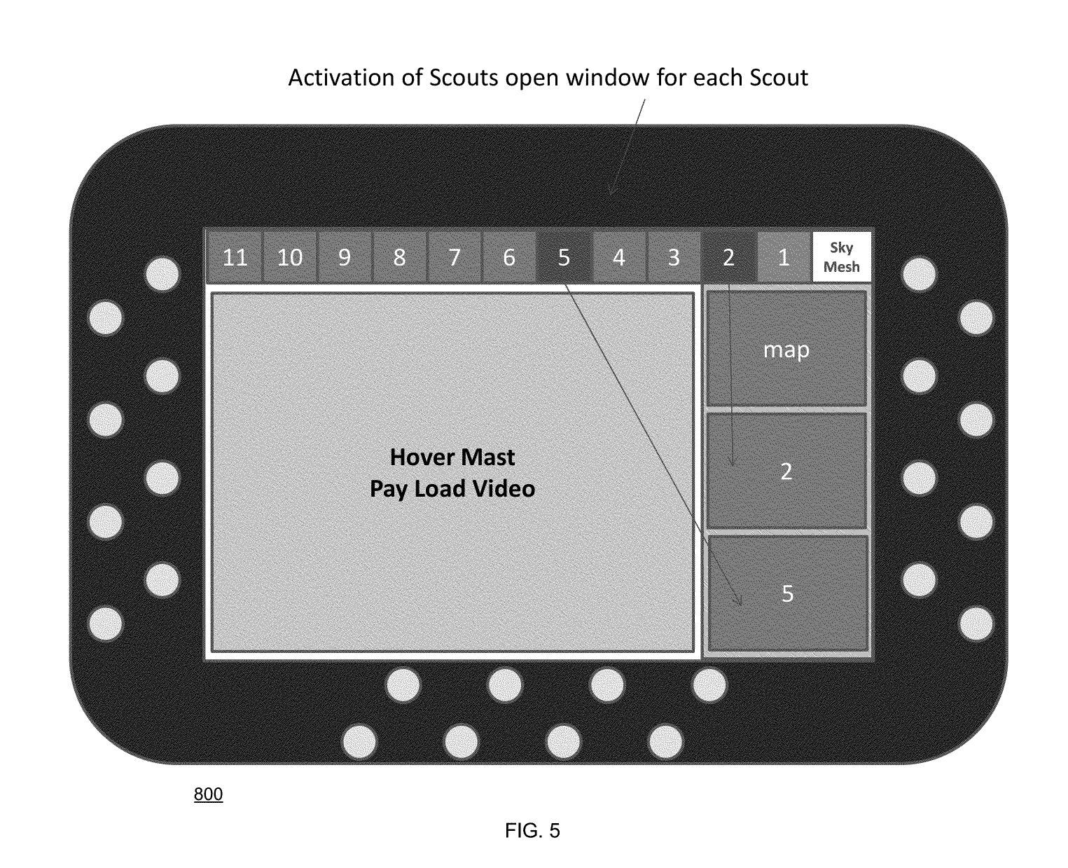

FIG. 5 illustrates an election of two additional monitoring devices (icons 2 and 5 of the horizontal line) and the allocation of two windows of the vertical sequence of windows for displaying content provided by additional monitoring devices represented by icons 2 and 5.

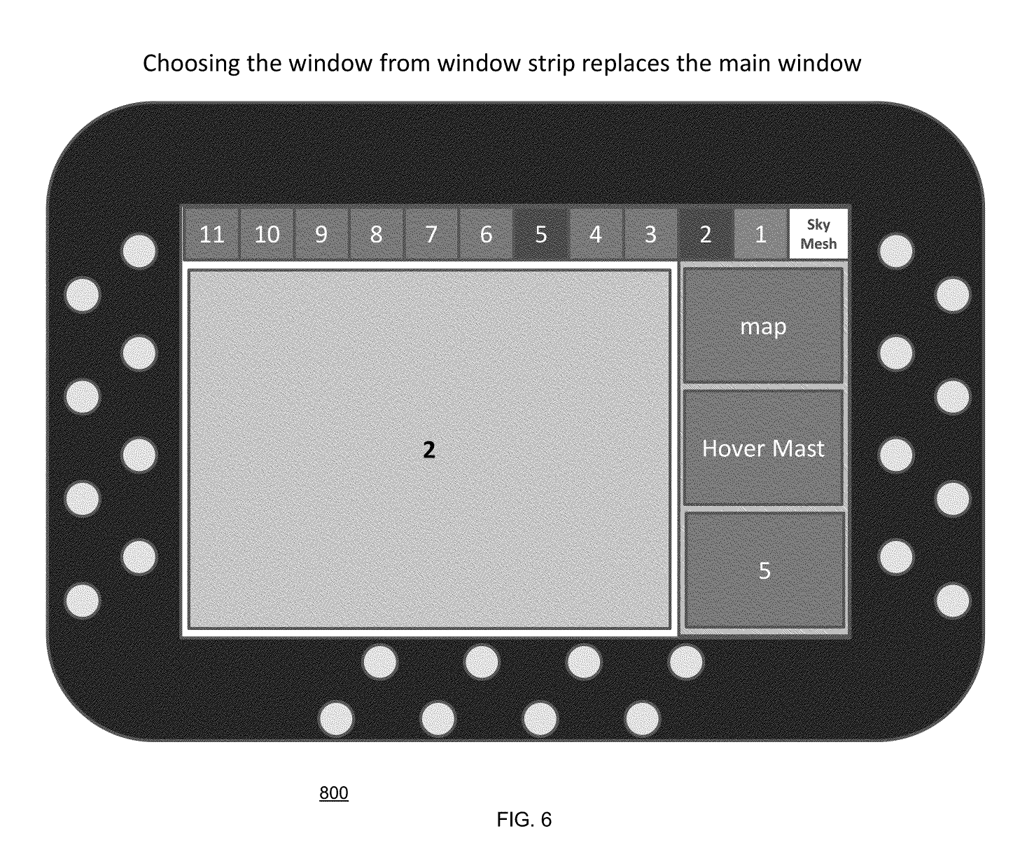

FIG. 6 illustrates a scenario in which the content obtained by the other monitoring device (represented by icon 2) is displayed in the center of the display (which form the largest window) while the content from aerial unit 300 is provided in one of the windows of the vertical sequence of windows.

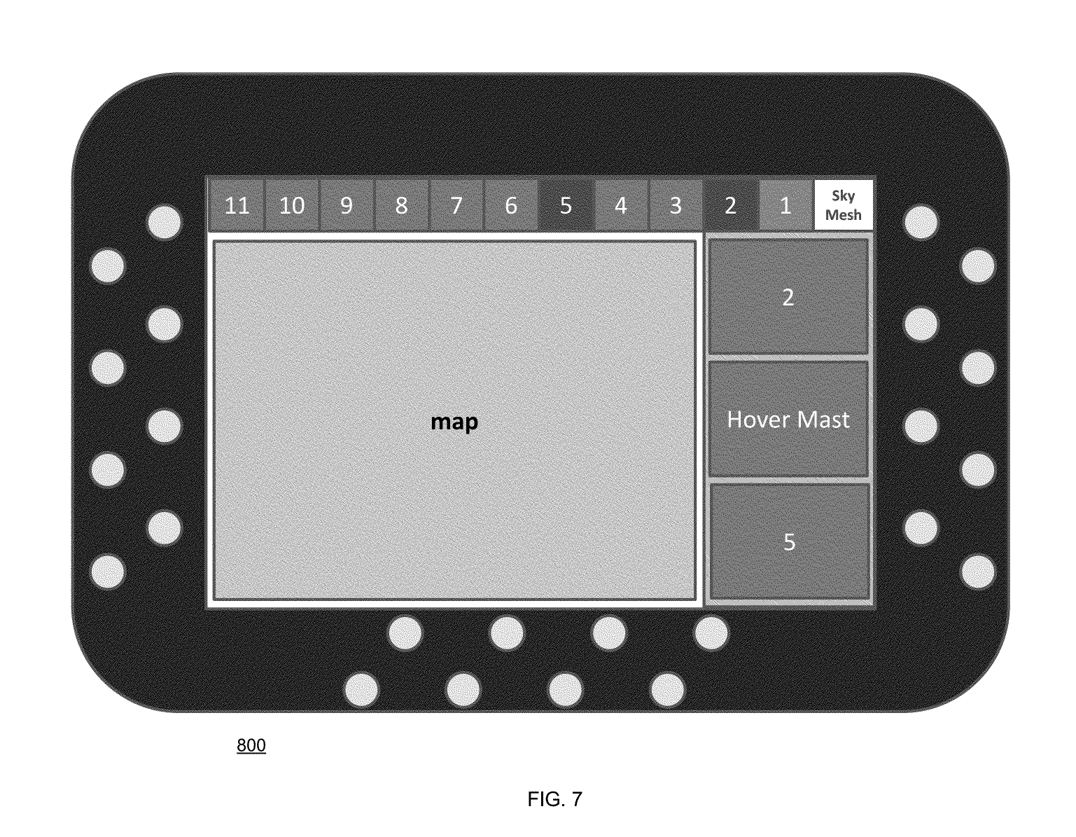

FIG. 7 illustrates a scenario in which a map is displayed in the center of the display (which form the largest window) while the content from aerial unit 300 is provided in one of the windows of the vertical sequence of windows.

It is noted that the number of windows, the shape of each window, the size of each window, the shape of each icon, the size of each icon and the number of icons may differ from those illustrated in FIGS. 3-9.

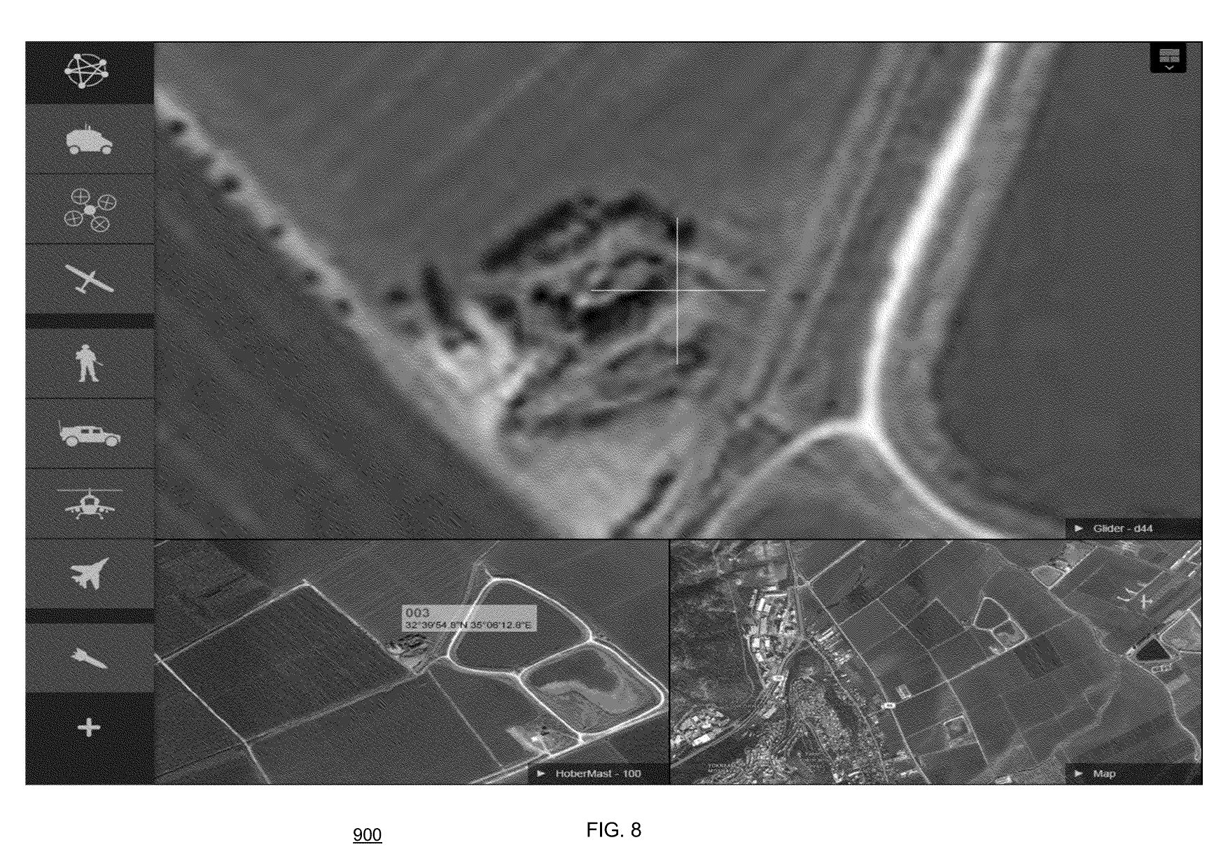

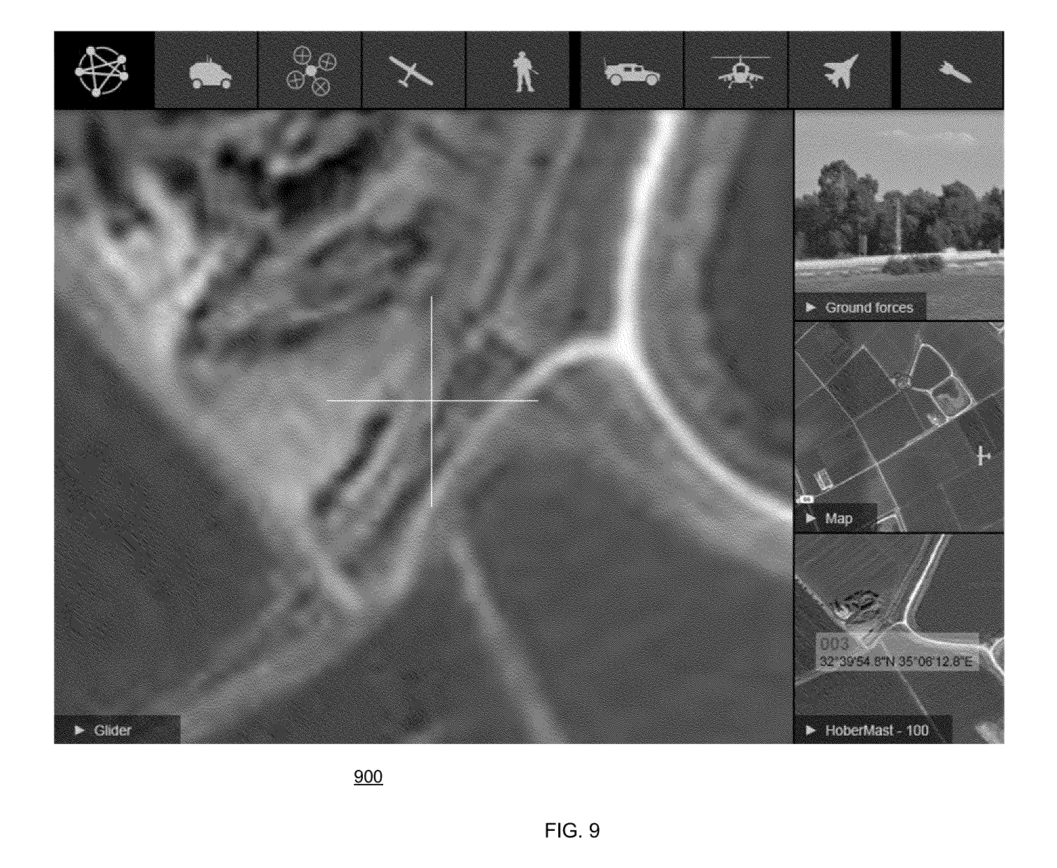

FIGS. 8 and 9 illustrates a sample of content provided from three monitoring devices (including aerial unit 300) and a vertical line of icons that represent different monitoring systems including a helicopter, an airplane, a ground vehicle, a rocket or missile, a solder and the like.

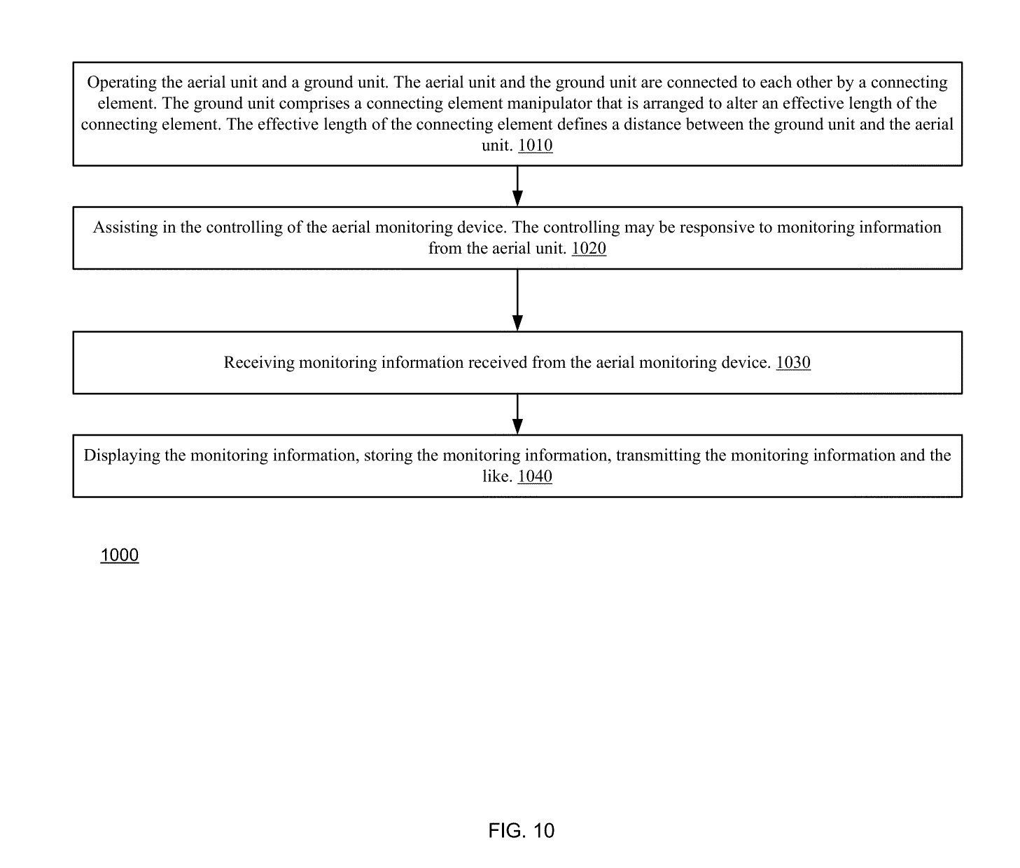

FIG. 10 illustrates method 1000 according to an embodiment of the invention.

Method 1000 may start by step 1010 of operating the aerial unit and a ground unit. Step 1010 may include receiving monitoring information from the aerial unit—such as one or more images of an area.

The aerial unit and the ground unit are connected to each other by a connecting element. The wherein the ground unit comprises a connecting element manipulator that is arranged to alter an effective length of the connecting element. The effective length of the connecting element defines a distance between the ground unit and the aerial unit. See, for example FIGS. 1A and 1B.

Step 1010 may be followed by step 1020 of assisting in the controlling of the aerial monitoring device. The controlling may be responsive to monitoring information from the aerial unit.

Step 1010 may proceed while other steps of method 1000 are executed.

Step 1020 may include, for example, selecting a target to be viewed by the aerial monitoring device. The selection may be done by a user and/or by the system.

The selection by the system may be responsive to the monitoring results obtained during step 1010 from the aerial unit. For example—once finding an object of interest (the object may be predefined) then selecting the object as a target. For example—detecting a suspicious vehicle within an area monitored during step 1010.

Step 1020 may include assisting in a controlling of the aerial monitoring device in response to instructions fed to the system by a user.

Step 1020 may include assisting in a controlling of the aerial monitoring device in an autonomous manner.

Step 1020 may include sending to the aerial monitoring device target information about a location of a target to be monitored by the aerial monitoring device.

Step 1020 may include sending to the aerial monitoring device control information that is relayed by the aerial unit.

Step 1020 may include assisting in a controlling of one or more additional aerial monitoring device that differs from the aerial unit.

Step 1020 may include sending control information to the aerial monitoring device to enable a monitoring of a target by the aerial monitoring device.

Step 1020 may be followed by step 1030 of receiving monitoring information received from the aerial monitoring device.

Step 1030 may be followed by step 1040 of displaying the monitoring information, storing the monitoring information, transmitting the monitoring information and the like.

Step 1040 may include displaying monitoring information received from the aerial unit at a first window and displaying monitoring information received from the aerial monitoring device at a second window.

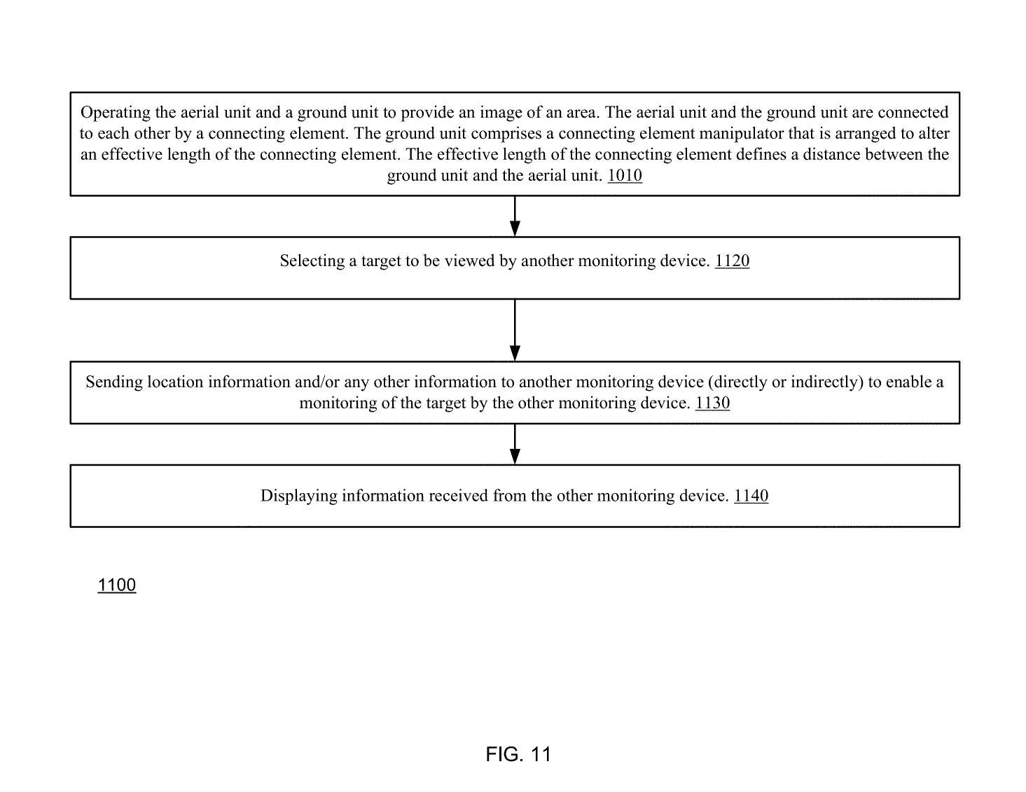

FIG. 11 illustrates method 1100 according to an embodiment of the invention.

Method 1100 may start by step 1110 of operating an aerial unit and a ground unit to provide an image of an area.

The aerial unit and the ground unit are connected to each other by a connecting element. The wherein the ground unit comprises a connecting element manipulator that is arranged to alter an effective length of the connecting element. The effective length of the connecting element defines a distance between the ground unit and the aerial unit. See, for example FIGS. 1A and 1B.

Step 1110 may be followed by step 1120 of selecting a target to be viewed by another monitoring device.

Step 1120 may be followed by step 1130 of sending location information and/or any other information to another monitoring device (directly or indirectly) to enable a monitoring of the target by the other monitoring device.

Step 1130 may be followed by step 1140 of and displaying information received from the other monitoring device.

Any reference to the term “comprising” or “having” should be interpreted also as referring to “consisting” of “essentially consisting of”. For example—a pool cleaning robot that comprises certain components can include additional components, can be limited to the certain components or may include additional components that do not materially affect the basic and novel characteristics of the pool cleaning robot—respectively.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front, ” “back, ” “top, ” “bottom, ” “over, ” “under ” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with ” each other such that the desired functionality is achieved, irrespective of architectures or intermedial components. Likewise, any two components so associated can also be viewed as being “operably connected, ” or “operably coupled, ” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a ” or “an, ” as used herein, are defined as one or more than one. Also, the use of introductory phrases such as “at least one ” and “one or more ” in the claims should not be construed to imply that the introduction of another claim element by the indefinite articles “a ” or “an ” limits any particular claim containing such introduced claim element to inventions containing only one such element, even when the same claim includes the introductory phrases “one or more ” or “at least one ” and indefinite articles such as “a ” or “an. ” The same holds true for the use of definite articles. Unless stated otherwise, terms such as “first” and “second ” are used to arbitrarily distinguish between the elements such terms describe. Thus, these terms are not necessarily intended to indicate temporal or other prioritization of such elements the mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim

1. A system, comprising a ground unit, an aerial unit and a connecting element that is arranged to connect the ground unit to the aerial unit;
wherein the ground unit comprises a connecting element manipulator that is arranged to alter an effective length of the connecting element; wherein the effective length of the connecting element defines a distance between the ground unit and the aerial unit;
wherein at least one out of the ground unit and the aerial unit comprises a controller; and
wherein the controller is configured to determine a manner in which the aerial unit operates and is further configured to assist in a controlling of an aerial monitoring device that differs from the aerial unit.

2. The system according to claim 1 wherein the controller is configured to assist in the controlling of the aerial monitoring device that differs from the aerial unit in response to instructions fed to the system by a user.

3. The system according to claim 1 wherein the controller is configured to assist in the controlling of the aerial monitoring device in an autonomous manner.

4. The system according to claim 1 wherein the controller is configured to assist in the controlling of the aerial monitoring device by sending, to the aerial monitoring device, target information about a location of a target to be monitored by the aerial monitoring device.

5. The system according to claim 1 wherein the controller is configured to assist in the controlling of the aerial monitoring device by sending, to the aerial monitoring device, control information that is relayed by the aerial unit.

6. The system according to claim 1 wherein the controller is configured to receive monitoring information from the aerial monitoring device and to control a display to a user of the monitoring information.

7. The system according to claim 1 comprising a display that is configured to display to a user monitoring information from the aerial monitoring device and monitoring information from the aerial unit.

8. The system according to claim 1 wherein the controller is configured to assist in a controlling of at least one additional aerial monitoring devices.

9. The system according to claim 1 wherein the aerial monitoring device is a satellite.

10. The system according to claim 1 wherein the aerial monitoring device is a blimp.

11. A system, comprising a ground unit, an aerial unit and a connecting element that is arranged to connect the ground unit to the aerial unit;
wherein the ground unit comprises a first controller and a connecting element manipulator that is arranged to alter an effective length of the connecting element; wherein the effective length of the connecting element defines a distance between the ground unit and the aerial unit;
wherein the first controller is configured to determine a manner in which the aerial unit operates; and
wherein the aerial unit comprises a second controller that is configured to assist in a controlling of an aerial monitoring device that differs from the aerial unit.

12. The system according to claim 11 wherein the aerial monitoring device differs from the aerial unit by at least one out of resolution a spectrum.

13. A method for controlling an aerial unit and an aerial monitoring device, the method comprising:
operating the aerial unit and a ground unit to provide an image of an area; wherein the aerial unit and the ground unit are connected to each other by a connecting element; wherein the ground unit comprises a connecting element manipulator that is arranged to alter an effective length of the connecting element; wherein the effective length of the connecting element defines a distance between the ground unit and the aerial unit;
selecting a target to be viewed by the aerial monitoring device;
sending control information to the aerial monitoring device to enable a monitoring of a target by the aerial monitoring device;
receiving monitoring information received from the aerial monitoring device; and
displaying the monitoring information.

14. The method according to claim 13 comprising assisting in a controlling of the aerial monitoring device in response to instructions fed by a user.

15. The method according to claim 13 comprising assisting in a controlling of the aerial monitoring device in an autonomous manner.

16. The method according to claim 13 comprising assisting in a controlling of the aerial monitoring device by sending to the aerial monitoring device target information about a location of a target to be monitored by the aerial monitoring device.

17. The method according to claim 13 comprising assisting in a controlling of the aerial monitoring device by sending to the aerial monitoring device control information that is relayed by the aerial unit.

18. The method according to claim 13 comprising assisting in a controlling of at least one additional aerial monitoring device that differs from the aerial unit.

19. The method according to claim 13 wherein the aerial monitoring device is a satellite.

20. The method according to claim 13 wherein the aerial monitoring device is a blimp.

21. The method according to claim 13 wherein the displaying the monitoring information comprises displaying monitoring information received from the aerial unit at a first window and displaying monitoring information received from the aerial monitoring device at a second window.
